(19) United States
(12) Patent Application Publication
(10) Pub. No.: US 2012/0274272 A1
(43) Pub. Date: Nov. 1, 2012

(54) RADIO FREQUENCY TRANSMISSION OF ENERGY FOR RECHARGING WIRELESS DEVICES AND TOOLS

(75) Inventors: Jesus Hinojosa, JR., Dallas, TX (US); Kermit D. Lopez, Albuquerque, NM (US)

(73) Assignee: Mesa Digital, LLC.

(21) Appl. No.: 13/411,082

(22) Filed: Mar. 2, 2012

Related U.S. Application Data
(60) Provisional application No. 61/479,462, filed on Apr. 27, 2011.

(51) Int. Cl. H02J 7/00

(52) U.S. Cl. 320/108; 320/137

(57) ABSTRACT

A system for transmitting microwave energy and recharging wireless devices and tools is disclosed. The system has a microwave source, electric power source, a microwave energy converter, a transmitter, a receiver, an electric energy converter, and a wireless device. When the charging level of a rechargeable battery of wireless device is low, the microwave energy converter converts microwave and electrical energy to microwave energy. The microwave energy is transmitted to the wireless device. The wireless device receives the microwave energy and the electric energy converter converts the microwave energy to the electrical energy. The electrical energy is utilized for charging the rechargeable battery of the wireless device.

### CROSS-REFERENCE TO PROVISIONAL APPLICATION

This patent application claims the benefit under 35 U.S.C. §119(e) of U.S. Provisional Application Ser. No. 61/479,462 entitled, “Radio Frequency Transmission of Energy for Recharging Wireless Devices and Tools,” which was filed on Apr. 27, 2011 and is incorporated herein by reference in its entirety.

### TECHNICAL FIELD

Embodiments are generally related to a device for wireless transmission and reception of electric power. Embodiments also relate to wireless charging of rechargeable devices. Embodiments additionally relate to the transmission of microwave energy for charging wireless devices and tools such as, for example, cordless power drills, yard tools, cellular telephones, laptop computers, and so forth.

### BACKGROUND OF THE INVENTION

Wireless Power Transmission (WPT) is an efficient technique of transmitting electric power from one point to another through a vacuum or the atmosphere without the use of wire or any other substance. WPT can be utilized for applications where either an instantaneous amount or a continuous delivery of energy is needed, but where conventional wires are unaffordable, inconvenient, expensive, hazardous, unwanted or impossible. The power can be transmitted using microwaves, millimeter waves or lasers.

Microwave transmission refers to the technology of transmitting information by the use of the radio waves whose wavelengths are conveniently measured in small numbers of centimeters by using various electronic technologies.

Microwave radio transmission is commonly used by communication systems on the surface of the Earth, in satellite communications, and in deep space radio communications. Other parts of the microwave radio band are used for radars, radio navigation systems, sensor systems, and radio astronomy.

The use of rechargeable devices such as, for example, drills, yard tools, and wireless hand held devices such as cell phones have been increased. Such devices require a direct connection or “touching” of the devices to an electric power source for recharging the device batteries. The charging of such devices would be a problem in a place where no direct electrical connection is possible. Therefore, there exists a need for wireless transmission of electric power for charging rechargeable electronic devices using microwaves.

### BRIEF SUMMARY

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for a device for wireless transmission and reception of electric power.

It is another aspect of the disclosed embodiments to provide wireless charging of rechargeable devices.

It is a further aspect of the present invention to provide transmission of microwave energy for charging wireless tools and devices such as, for example, drills, yard tools, and cell phones.

### BRIEF DESCRIPTION OF THE DRAWINGS

The accompanying figures, in which like reference numerals refer to identical or functionally-similar elements throughout the separate views and which are incorporated in and form a part of the specification, further illustrate the disclosed embodiments and, together with the detailed description of the invention, serve to explain the principles of the disclosed embodiments.

FIG. 1 illustrates a simplified block diagram of a system for transmitting microwave energy to recharge a wireless device through a wireless transmission medium, in accordance with the disclosed embodiments;

FIG. 2 illustrates a flow diagram depicting the transmission of electric power as microwave energy to rechargeable batteries of a wireless device through a wireless transmission medium, in accordance with the disclosed embodiments; and

FIG. 3 illustrates a flow chart depicting the process of transmitting microwave energy to a rechargeable device through a wireless transmission medium, in accordance with the disclosed embodiments.

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

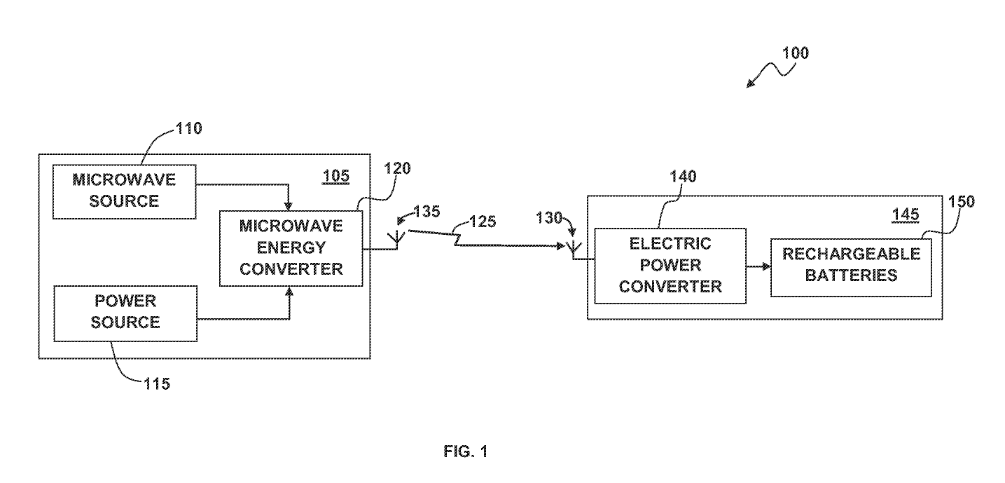

FIG. 1 illustrates a simplified block diagram of a system 100 for transmitting microwave energy to a rechargeable wireless device 145 through a wireless transmission medium, in accordance with the disclosed embodiments. The system 100 has a microwave energy generator 105 and the wireless device 145. The microwave energy generator 105 can be configured to include a microwave source 110, an electric power source 115, a transmitter 135, and a microwave energy converter 120. The wireless device 145 has a receiver 130, an electric power convertor 140, and rechargeable batteries 150. The microwave energy convertor 140 converts a low level microwave from microwave source 110 and an electric power from power source 115 to low level microwave energy. The transmitter 135 transmits the microwave energy 125 via Radio Frequency (RF) to the receiver 130.

In general, the system 100 utilizes microwave transmission, which involves transmitting information via the use of radio waves whose wavelengths are generally measured in small numbers of centimeters via electronic technologies. These are called microwaves. This part of the radio spectrum ranges across frequencies of roughly 1.0 gigahertz (GHz) to 30 GHz. Also, by using the formula λ=c/f, these correspond to wavelengths from 30 centimeters down to 1.0 cm. [In the above equation, the Greek letter λ (lambda) is the wavelength in meters; c is the speed of light in meters per second; and f is the frequency in hertz (Hz).] Thus, the transmitter 135 is capable of microwave transmission.

The electric power converter 140 converts the microwave energy received by the receiver 130 to electric power. The electric power is utilized to charge the rechargeable batteries 150 of wireless device 145. The wireless device 145 can be a rechargeable device such as tools and wireless devices. The tools can be drills, yard tools, etc., and the wireless devices can be cell phones, smartphones, laptop computers or any device containing a rechargeable battery.

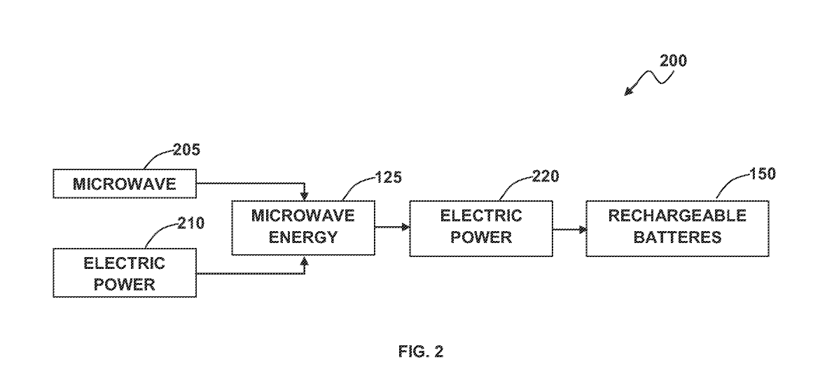

FIG. 2 illustrates a flow diagram 200 depicting the transmission of electric power 210 as microwave energy 125 to rechargeable batteries 150 of a wireless device 145 through a wireless transmission medium, in accordance with the disclosed embodiments. The microwave 205 and electric power 210 are converted to microwave energy 125. The microwave energy 125 is transmitted to the wireless device 145 via Radio Frequency (RF). The wireless device 145 depicted in FIG. 1 receives microwave energy 125 and converts to electric power 220. The converted electric power 220 is utilized for charging the rechargeable batteries 150 of wireless device 145 depicted in FIG. 1.

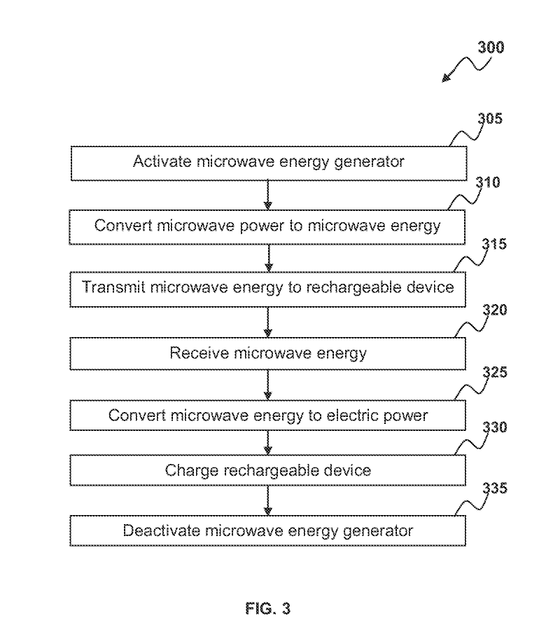

FIG. 3 illustrates a flow chart 300 depicting the process of transmitting microwave energy to a rechargeable device through a wireless transmission medium, in accordance with the disclosed embodiments. When the charging level of a rechargeable device is low, the microwave energy generator is activated as said at block 305. Then as illustrated at block 310 and 315, the microwave and electric power are converted to microwave energy and transmitted to the rechargeable device. The rechargeable device receives the microwave energy and converts it to electric power as depicted at block 320 and 325. As said at block 330, the electric power is utilized to charge the rechargeable device. Finally, once the charging of the rechargeable device is completed, the microwave energy generator is deactivated as illustrated at block 335.

Based on the foregoing, it can be appreciated that a number of embodiments, preferred and alternative, are disclosed herein. For example, in one embodiment, an apparatus can be provided for radio frequency transmission of energy for wirelessly recharging of a wireless device. Such an apparatus may include, for example, a microwave energy generator that connects electrically to a microwave source and an electric power source; and a transmitter and a microwave energy converter, wherein said transmitter is connected electrically to said microwave energy converter and wirelessly transmits microwave energy for wireless transmission to and recharging of a wireless device. In an alternative embodiment, the aformentioned wireless device can comprise one or more rechargeable batteries. In another embodiment, the wireless device can communicate electrically with a receiver, wherein said receiver receives said microwave energy wirelessly from said transmitter.

In yet another embodiment, the wireless device can include at least one rechargeable battery and communicates electrically with a receiver, wherein said receiver receives said microwave energy wirelessly from said transmitter. In still another embodiment, an electrical power converter can be provided for converting said microwave energy to electrical power and transmitting said electric power to said at least one rechargeable battery for recharging of said wireless device.

In yet another embodiment, a system for radio frequency transmission of energy for recharging a wireless device can be provided. Such a system can include, for example, a microwave energy generator for generating microwave energy said microwave generator comprising a microwave source, an electric power source, a microwave energy convertor and a transmitter for wirelessly transmitting microwave energy to a wireless device; and a receiver associated with and which communicates with said wireless device, wherein said receiver receives microwave energy transmitted from said microwave energy generator, an electrical power convertor for converting microwave energy to electric power, and at least one rechargeable battery. In an another embodiment of such a system, microwave energy can be transmitted via Radio frequency.

In another system embodiment, the microwave energy convertor can convert microwave from said microwave source and electric power from said electric power source to microwave energy. In yet another embodiment of such a system, wherein at least rechargeable battery can be charged by electric power from said electric power converter. In still another embodiment of such a system, the microwave energy can be transmitted via Radio frequency and wherein said microwave energy convertor converts microwave from said microwave source and electric power from said electric power source to microwave energy. In still another system embodiment, the microwave energy convertor can convert microwave from said microwave source and electric power from said electric power source to microwave energy and wherein said at least rechargeable battery is charged by electric power from said electric power converter.

In another embodiment, a method for radio frequency transmission of energy for wirelessly recharging of a wireless device can be implemented. Such a method can include the steps of, for example, electrically connecting a microwave energy generator to a microwave source and an electric power source; providing a transmitter and a microwave energy converter; electrically connecting said transmitter to said microwave energy converter; and wirelessly transmitting microwave energy for wireless transmission to and recharging of a wireless device via said microwave energy converter, said transmitter, said microwave energy generator, said microwave source, and said electric power source.

It will be appreciated that variations of the above disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. An apparatus for radio frequency transmission of energy for wirelessly recharging of a wireless device, said apparatus comprising:
a microwave energy generator that connects electrically to a microwave source and an electric power source; and
a transmitter and a microwave energy converter, wherein said transmitter is connected electrically to said microwave energy converter and wirelessly transmits microwave energy for wireless transmission and recharging of a wireless device.

2. The apparatus of claim 1 wherein said wireless device comprises at least one rechargeable battery.

3. The apparatus of claim 1 wherein said wireless device communicates electrically with a receiver, wherein said receiver receives said microwave energy wirelessly from said transmitter.

4. The apparatus of claim 1 wherein said wireless device comprises at least one rechargeable battery and communicates electrically with a receiver, wherein said receiver receives said microwave energy wirelessly from said transmitter.

5. The apparatus of claim 2 further comprising an electrical power converter for converting said microwave energy to electrical power and transmitting said electric power to said at least one rechargeable battery for recharging of said wireless device.

6. The apparatus of claim 4 further comprising an electrical power converter for converting said microwave energy to electrical power and transmitting said electric power to said at least one rechargeable battery for recharging of said wireless device.

7. A system for radio frequency transmission of energy for recharging a wireless device, said system comprising:
a microwave energy generator for generating microwave energy said microwave generator comprising a microwave source, an electric power source, a microwave energy convertor, and a transmitter for wirelessly transmitting microwave energy to a wireless device; and
a receiver associated with and which communicates with said wireless device, wherein said receiver receives microwave energy transmitted from said microwave energy generator, an electrical power convertor for converting microwave energy to electric power, and at least one rechargeable battery.

8. The system of claim 7 wherein said microwave energy is transmitted via Radio frequency.

9. The system of claim 7 wherein said microwave energy convertor converts microwave from said microwave source and electric power from said electric power source to microwave energy.

10. The system of claim 1 wherein said at least rechargeable battery is charged by electric power from said electric power converter.

11. The system of claim 7 wherein said microwave energy is transmitted via Radio frequency and wherein said microwave energy convertor converts microwave from said microwave source and electric power from said electric power source to microwave energy.

12. The system of claim 7 wherein said microwave energy convertor converts microwave from said microwave source and electric power from said electric power source to microwave energy and wherein said at least rechargeable battery is charged by electric power from said electric power converter.

13. An method for radio frequency transmission of energy for wirelessly recharging of a wireless device, said method comprising:
electrically connecting a microwave energy generator to a microwave source and an electric power source;
providing a transmitter and a microwave energy converter;
electrically connecting said transmitter to said microwave energy converter; and
wirelessly transmitting microwave energy for wireless transmission to and recharging of a wireless device via said microwave energy converter, said transmitter, said microwave energy generator, said microwave source, and said electric power source

14. The method of claim 13 further comprising configuring said wireless device to comprise at least one rechargeable battery.

15. The method of claim 13 configuring said wireless device to communicate electrically with a receiver, wherein said receiver receives said microwave energy wirelessly from said transmitter.

16. The method of claim 13 further comprising configuring said wireless device to comprise at least one rechargeable battery and communicates electrically with a receiver, wherein said receiver receives said microwave energy wirelessly from said transmitter.

17. The method of claim 14 further comprising providing an electrical power converter for converting said microwave energy to electrical power and transmitting said electric power to said at least one rechargeable battery for recharging of said wireless device.

18. The method of claim 16 further comprising providing an electrical power converter for converting said microwave energy to electrical power and transmitting said electric power to said at least one rechargeable battery for recharging of said wireless device.
